(19) United States
(12) Patent Application Publication
(10) Pub. No.: US 2015/0195649 A1
(43) Pub. Date: Jul. 9, 2015

(54) METHOD FOR PROXIMITY BASED AUDIO DEVICE SELECTION

(71) Applicant: Flyover Innovations, LLC, Kansas City, MO (US)

(72) Inventor: MARK VOGT, Kansas City, MO (US)

(21) Appl. No.: 14/489,085

(22) Filed: Sep. 17, 2014

Related U.S. Application Data
(63) Continuation of application No. 14/099,965, filed on Dec. 8, 2013, now abandoned.

(51) Int. Cl. H04R 3/12; G08C 17/02

(52) U.S. Cl. CPC H04R 3/12; G08C 17/02; G08C 2201/91

(57) ABSTRACT

A method for devices to remote control and stream audio signals to nearby audio devices in a wireless network based audio system. The wireless audio devices are on a segregated wireless network set up by a network bridge connected to a home wireless router. The method includes an application enabled remote control device establishing a proximity based wireless connection with nearby wireless audio devices by scanning the surrounding area for wireless signals from wireless audio devices; identifying the wireless audio devices that are in close proximity based on their wireless signal strength being above a proximity threshold; and sending remote control and audio signals to the selected wireless audio devices.

### CROSS REFERENCE TO RELATED APPLICATIONS

This application is a continuation application of and claims priority and the benefit of the filing date of U.S. patent application Ser. No. 14/099,965, filed Dec. 8, 2013, and titled “METHOD FOR PROXIMITY BASED AUDIO DEVICE SELECTION”, the subject matter of which is hereby incorporated by reference in its entirety.

### BACKGROUND OF THE INVENTION

The present invention is generally related to a system to enable proximity based wireless remote control of audio systems. More specifically, the present invention relates to using smart devices for remote control and audio streaming to audio devices that are identified to be in close proximity.

In recent years, more and more audio devices are being used at various locations in and around our homes. This leads to the presence of a multitude of remote control devices in our lives. Remote control devices are becoming more sophisticated with additional capabilities and features. Home audio systems are getting more complicated and harder to control. They typically do not have a means to select audio devices close to the user.

Modern day hand-held devices are also becoming increasingly powerful. Examples of these smart devices include smart phones, music players, electronic tablets, etc. More specifically, these devices include iOS products like the iPhone™, iPod Touch™ and iPad™ devices (manufactured and sold by Apple Inc.), smart phones and tablets by Blackberry™ Android™ phones and tablets, and touch screen devices by Motorola, Samsung and others. These devices all include processors capable of performing multiple tasks and supporting many different “applications”. Some such applications enable these smart hand-held devices to be used as remote control devices. With the increasing use of smart hand-held devices as remote control devices, we are starting to face situations where there are multiple devices for the same remote control. There is a need for a system to identify the nearby controllable devices close to the remote control device. The present invention addresses such a need in audio systems.

### BRIEF SUMMARY OF THE INVENTION

The present invention discloses a method for devices to remote control and stream audio signals to nearby audio devices in a wireless network based audio system. The invention includes a wireless network bridge that interfaces with multiple audio devices on the same wireless network, a home wireless router that is connected to the said network bridge and an application enabled remote control device which interfaces with the said home wireless router while establishing a proximity based wireless connection with the said audio devices.

The said audio devices are on a segregated wireless network set up by said network bridge connected to said home wireless router. The said remote control device establishes a proximity based wireless connections with the said audio devices to identify audio devices in close proximity. The said audio devices therefore have two established wireless connections during operation; The first said audio device wireless connection is with the said network bridge and the second audio device wireless connection is with the said remote control device. Smart devices can act as remote control and transmitter devices for the said audio systems. The said smart remote control device streams audio data to the said network bridge via the said home wireless router to stream the audio data and remote control said audio device.

### BRIEF DESCRIPTION OF THE DRAWINGS

FIG. 1 is a representative illustration of all the components in the invention.

FIG. 2 is a block diagram representing the method to stream audio to devices in close proximity.

FIG. 3 is a block diagram representing the method of switching between audio device groups.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Homes today typically have multiple audio devices. There is a need for the ability to control and stream audio to one or more speakers on an as needed basis. The invention involves multiple audios devices on a segregated wireless network that can be controlled by remote control devices. A network bridge connected to the home wireless router segregates the audio device wireless network from the home wireless network. The remote control device streams audio data to selected audio devices through the network bridge. Smart devices can act as remote control and transmitter devices for the said audio devices. The selected audio devices are chosen by the user based on Bluetooth signal strength to the smart remote control device.

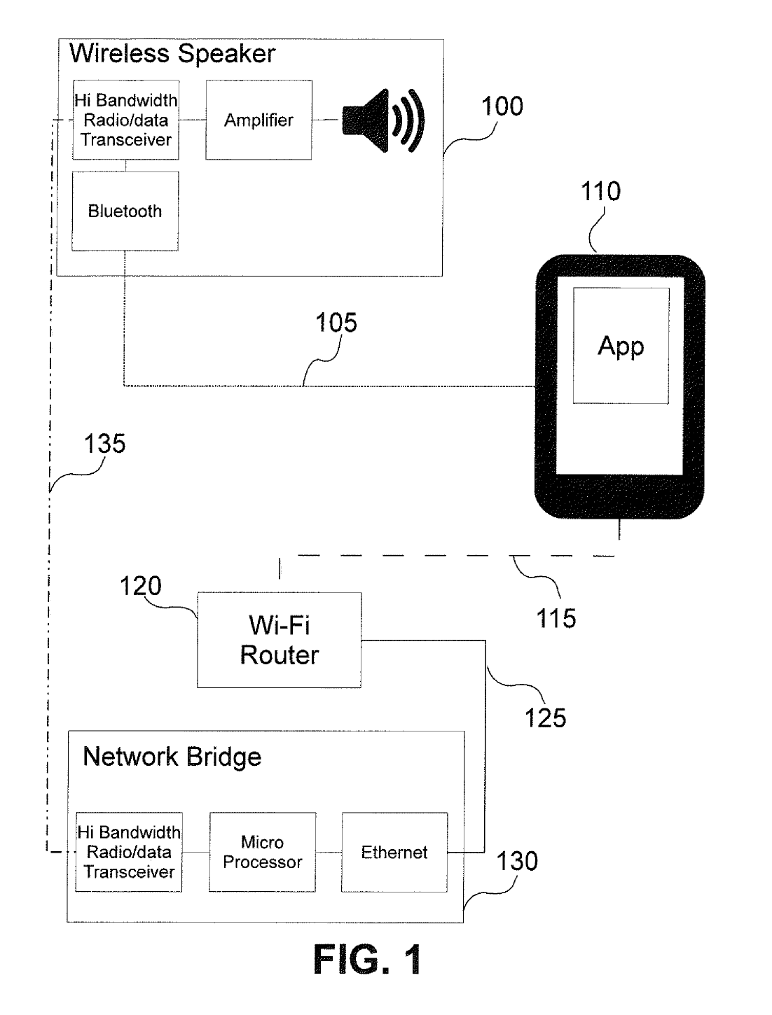

Referring now to FIG. 1, there is shown a representative illustration of all the main components in a preferred embodiment of the system. The audio devices 100 are designed to communicate with smart remote control devices 110 via Bluetooth signals 105 and to receive audio signals on a private wireless network 135. The said audio devices 100 have a RF chip for Bluetooth communication 105 with the said smart devices 110 and a RF chip for high bandwidth audio streaming. The said audio devices 100 have a unique identifier like a MAC ID or a UUID associated with them. The network bridge 130 creates a private wireless network 135 for the said audio devices 100 from the home wireless network set up through the home wireless router 120. The said smart control devices 110 have a software app to detect and control the closest audio devices based on Bluetooth signal strength. The user sets up groupings of the audio devices in the said software app depending on the usage of the said audio devices 100. The user selects the group of audio devices from the said detected audio devices to stream audio data. The smart remote control device 110 streams audio data 115 to the said home wireless router 120 which transmits it over the home wireless network 125 to the said network bridge 130 to stream to the said selected audio devices 100.

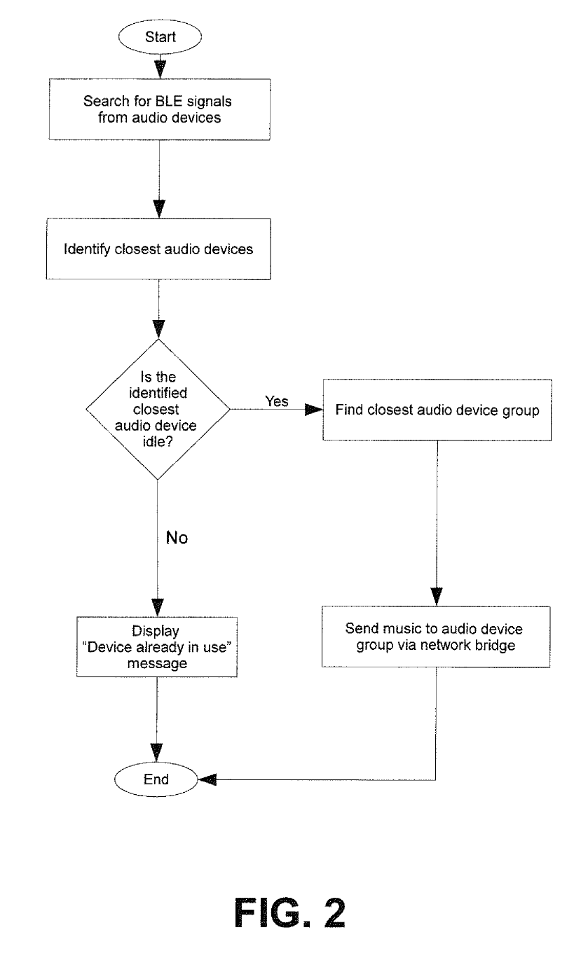

FIG. 2 shows a block diagram representation of the method to stream audio signals to nearby audio devices. The said smart remote control device 110 searches for any available low bandwidth Bluetooth RF signals from said audio devices 100. The said smart remote control device 110 identifies audio devices 100 in close proximity based on RF signal strength from said audio devices 100 exceeding a set threshold limit. The said smart remote control device 110 then scans the said identified audio devices 100 in close proximity to determine if the said identified audio devices are idle or in use. The said smart remote control device 110 displays a message to show the user if the nearest audio device 100 is already in use. If the said identified audio device 100 is available, the said smart remote control device 110 identifies the audio device group. The said smart remote control device 110 then streams audio signals through a high bandwidth path to the said identified audio device group via the home wireless router 120 and the network bridge 130.

The said identified audio devices in close proximity may not all be in the same room or area. In such circumstances the user can select the ones that are suitable from the identified available audio device or groups of audio devices.

The disclosed system is based on low bandwidth Bluetooth for smart control device communication and high bandwidth RF for audio streaming. Proximity detection can be accomplished by sensing any RF signal, infra red and other remote control communication technologies. A GPS based or triangulation based positioning system based on a priori knowledge of audio devices at particular locations from user input or network information may also be used to identify audio devices in close proximity.

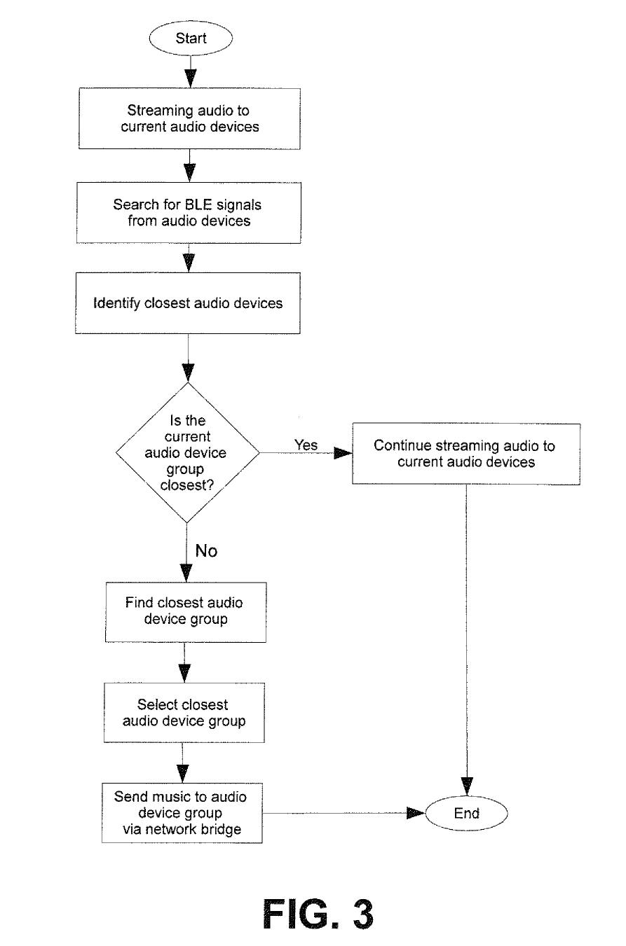

A block diagram representation of the method of switching audio devices to stream audio signals to is shown in FIG. 3. While streaming audio to a preselected audio device group, the smart remote control device continuously scans the area for available low bandwidth RF signals to identify audio devices in close proximity. A user may move to another area of the house while streaming audio to a set of previously selected audio devices and want to stream audio to audio devices that are now in close proximity to the user. If the previously selected devices are the closest ones, then the smart remote control device will continue to stream audio to them. If the previously selected devices are not the closest ones, then the smart remote control device identifies audio devices in close proximity based on audio device RF signal exceeding the set threshold limit. The said smart control device identifies if the said audio device is in a group and determines the said newly identified audio device grouping. The said smart control device then scans the said newly identified audio device group in close proximity to determine if the said newly identified audio device group is idle or in use. The said smart control device displays a message to show the user if the said newly identified audio device group is already in use. If the said newly identified audio device group is available, the said smart control device then streams audio signals through a high bandwidth path to the said newly identified audio device group via the said home wireless router and said network bridge.

What is claimed is:

1. A method of proximity selection of wireless audio devices comprising:
an audio streaming remote control device scanning the surrounding area for wireless signals from wireless audio devices;
identifying the wireless audio devices that are in close proximity based on their wireless signal strength being above a proximity threshold; and
sending remote control and audio signals to the selected wireless audio devices.

2. The method of claim 1, wherein the wireless home audio devices have unique identities and are on a segregated network formed by a network bridge.

3. The method of claim 1, wherein the audio streaming remote control device sends remote control and audio signals to a network router to forward to the selected wireless audio devices.

4. The method of claim 1, wherein the wireless audio devices communicate with the smart device and communicate with the network bridge using distinct modes.

5. The method of claim 1, wherein the wireless audio devices may be grouped by location by the remote control device user.

6. The method of claims 1, wherein the remote control device continues to scan the surrounding area for wireless signals from wireless audio devices while streaming audio to previously selected wireless audio devices;
identifies the wireless devices that are in close proximity when the user moves to another area;
allows the user to select other wireless audio device groups; and
sends remote control and audio signals to the newly selected wireless audio devices.

7. A method of proximity selection of wireless audio devices comprising:
an audio streaming remote control device scanning the surrounding area for wireless audio devices;
identifying the wireless audio devices that are in close proximity based on a positioning system dependent on a priori knowledge of wireless audio device locations; and
sending remote control and audio signals to the selected wireless audio devices.

8. The method of claim 7, wherein the wireless home audio devices have unique identities and are on a segregated network formed by a network bridge.

9. The method of claim 7, wherein the audio streaming remote control device sends remote control and audio signals to a network router to forward to the selected wireless audio devices.

10. The method of claim 7, wherein the wireless audio devices communicate with the smart device and communicate with the network bridge using distinct modes.

11. The method of claim 7, wherein the wireless audio devices may be grouped by location by the remote control device user.

12. The method of claims 7, wherein the remote control device continues to scan the surrounding area for wireless signals from wireless audio devices while streaming audio to previously selected wireless audio devices;
identifies the wireless devices that are in close proximity when the user moves to another area;
allows the user to select other wireless audio device groups; and
sends remote control and audio signals to the newly selected wireless audio devices.

13. A method of proximity selection of wireless audio devices comprising:
an audio streaming remote control device scanning the surrounding area for wireless audio devices;
identifying the wireless audio devices that are in close proximity based on a triangulation method dependent on a priori knowledge of wireless audio device locations; and
sending remote control and audio signals to the selected wireless audio devices.

14. The method of claim 13, wherein the wireless home audio devices have unique identities and are on a segregated network formed by a network bridge.

15. The method of claim 13, wherein the audio streaming remote control device sends remote control and audio signals to a network router to forward to the selected wireless audio devices.

16. The method of claim 13, wherein the wireless audio devices communicate with the smart device and communicate with the network bridge using distinct modes.

17. The method of claim 13, wherein the wireless audio devices may be grouped by location by the remote control device user.

18. The method of claims 13, wherein the remote control device continues to scan the surrounding area for wireless signals from wireless audio devices while streaming audio to previously selected wireless audio devices;
identifies the wireless devices that are in close proximity when the user moves to another area.
